(19) United States
(12) Patent Application Publication
(10) Pub. No.: US 2022/0291346 A1
(43) Pub. Date: Sep. 15, 2022

(54) ILLUMINATION DEVICE AND RANGING MODULE

(71) Applicant: SONY SEMICONDUCTOR SOLUTIONS CORPORATION, Kanagawa (JP)

(72) Inventor: Hirataka UKAI, Kanagawa (JP)

(73) Assignee: SONY SEMICONDUCTOR SOLUTIONS CORPORATION, Kanagawa (JP)

(21) Appl. No.: 17/634,322

(22) PCT Filed: Aug. 12, 2020
(86) PCT No.: PCT/JP2020/030645

§ 371 Date: Feb. 10, 2022

(30) Foreign Application Priority Data
Aug. 26, 2019 (JP) 2019-153489

(51) Int. Cl. G01S 7/481; G02B 7/10; G01S 17/931

(52) U.S. Cl. CPC G01S 7/4815; G02B 7/10; G01S 17/931

(57) ABSTRACT

There is provided systems and methods of using systems including a light emitting section, a projection lens; and a switch. The projection lens is configured to project light emitted from the light emitting section. The switch is configured to switch the projected light between a first configuration for area irradiation and a second configuration for spot irradiation.

### TECHNICAL FIELD

The present technology relates to an illumination device and a ranging module and in particular to an illumination device and a ranging module that can contribute to reductions in size and price while achieving both spot illumination and area illumination.

### CROSS REFERENCE TO RELATED APPLICATIONS

This application claims the benefit of Japanese Priority Patent Application JP 2019-153489 filed Aug. 26, 2019, the entire contents of which are incorporated herein by reference.

### BACKGROUND ART

In recent years, since the semiconductor technology has made progress, ranging modules configured to measure distances to objects have been reduced in size. As a result, for example, smartphones having mounted thereon ranging modules are on sale.

A ToF (Time of Flight) ranging module applies light toward an object and detects light that is reflected by the object surface to thereby calculate a distance to the object on the basis of a measurement value obtained by measuring the time-of-flight of the light.

In a case where spot light is applied as irradiation light that is applied toward an object, there is an advantage that the distance measurement accuracy can be enhanced with high light power density. However, since it is difficult to measure distances to parts not irradiated with the spot light, there is a problem of low resolution.

To deal with this problem, PTL 1 proposes using light sources having the two patterns of spot light and area light, to thereby obtain both the advantages of low multipath and high resolution.

### CITATION LIST

### Patent Literature

PTL 1: U.S. Patent Application Publication No. 2013/0148102

### SUMMARY OF INVENTION

### Technical Problem

However, two irradiation modules for spot illumination and area illumination may be required, leading to concerns about increases in size and cost of the modules.

The present technology has been made in view of such a circumstance, and it is desirable to contribute to reductions in size and price while achieving both spot illumination and area illumination.

### Solution to Problem

According to an embodiment of the present disclosure, there is provided a system comprising: a light emitting section; a projection lens configured to project light emitted from the light emitting section; and a switch configured to switch the projected light between a first configuration for area irradiation and a second configuration for spot irradiation. According to aspects of the present disclosure, there is provided a system wherein the switch changes a focal length of the projection lens by moving the projection lens between at least a first position and a second position. According to aspects of the present disclosure, there is provided a system wherein in the first position the projection lens performs area irradiation. According to aspects of the present disclosure, there is provided a system wherein in the second position the projection lens performs spot irradiation. According to aspects of the present disclosure, there is provided a system wherein the light emitting section includes a light source array in which a plurality of light sources configured to emit light with a predetermined opening size are arrayed with a predetermined inter-light source distance. According to aspects of the present disclosure, there is provided a system wherein a light source driving section controls a position of the light emitting section from a first light source position for spot irradiation to a second light source position for area irradiation. According to aspects of the present disclosure, there is provided a system wherein the projection lens is a variable focus lens. According to aspects of the present disclosure, there is provided a system wherein the switch is configured to switch between the first configuration and the second configuration by changing a refractive power of the projection lens. According to embodiments of the present disclosure, there is provided a method of driving a system, the method comprising: projecting light in an area irradiation configuration from a light emitting section of the system through a projection lens of the system; switching, with a switch of the system, the projected light from the area irradiation configuration to a spot irradiation configuration; and projecting light in the spot irradiation configuration from the light emitting section through the projection lens. According to aspects of the present disclosure, there is provided a method wherein the switch changes a focal length of the projection lens by moving the projection lens between at least a first position and a second position. According to aspects of the present disclosure, there is provided a system wherein in the first position the projection lens performs area irradiation. According to aspects of the present disclosure, there is provided a system wherein in the second position the projection lens performs spot irradiation. According to aspects of the present disclosure, there is provided a system wherein the light emitting section includes a light source array in which a plurality of light sources configured to emit light with a predetermined opening size are arrayed with a predetermined inter-light source distance. According to aspects of the present disclosure, there is provided a system wherein a light source driving section controls a position of the light emitting section from a first light source position for spot irradiation to a second light source position for area irradiation. According to aspects of the present disclosure, there is provided a system wherein the projection lens is a variable focus lens. According to aspects of the present disclosure, there is provided a system wherein the switch is configured to switch from the area irradiation configuration to the spot irradiation configuration by changing a refractive power of the projection lens. According to embodiments of the present disclosure, there is provided a system comprising: a light emitting section; a projection lens configured to project light emitted from the light emitting section; a switch configured to switch between a first configuration for area irradiation and a second configuration for spot irradiation; and a light receiving section configured to receive reflected light. According to aspects of the present disclosure, there is provided a system wherein the switch changes a focal length of the projection lens by moving the projection lens between at least a first position and a second position. According to aspects of the present disclosure, there is provided a system wherein in the first position the projection lens performs area irradiation. According to aspects of the present disclosure, there is provided a system wherein in the second position the projection lens performs spot irradiation. According to an embodiment of the present technology, there is provided an illumination device including a light emitting section, a projection lens configured to project light that is emitted from the light emitting section, and a switching section configured to change a focal length to switch spot irradiation and area irradiation.

According to another embodiment of the present technology, there is provided a ranging module including: an illumination device; and a light receiving section configured to receive reflected light that is light emitted from the illumination device to be reflected by an object. The illumination device includes a light emitting section, a projection lens configured to project light that is emitted from the light emitting section, and a switching section, or switch, configured to change a focal length to switch spot irradiation and area irradiation.

In the embodiments of the present technology, the focal length is changed to switch spot irradiation and area irradiation.

The illumination device and the ranging module may be independent devices or modules that are incorporated in other devices.

### BRIEF DESCRIPTION OF DRAWINGS

FIG. 1 is a block diagram illustrating a configuration example of a ranging module of one embodiment to which the present technology is applied.

FIG. 2 is a diagram illustrating irradiation images of spot irradiation and area irradiation.

FIG. 3 is a diagram illustrating an Indirect ToF distance measurement method.

FIG. 4 is a sectional view illustrating a first configuration example of an illumination device.

FIG. 5A and FIG. 5B depict sectional views illustrating a movement of a projection lens in switching between spot irradiation and area irradiation.

FIG. 6A and FIG. 6B depict views illustrating each parameter.

FIG. 7A and FIG. 7B are diagrams illustrating spot light overlapping at a lower limit value.

FIG. 8A and FIG. 8B are diagrams illustrating spot light overlapping at an upper limit value.

FIG. 9 is a graph in which the lower limit value and upper limit value of the movement amount of the projection lens are plotted.

FIG. 10 is a sectional view illustrating a second configuration example of the illumination device.

FIG. 11 is a sectional view illustrating a third configuration example of the illumination device.

FIG. 12 is a graph in which the lower limit value and upper limit value of a refractive power of a variable focus lens are plotted.

FIG. 13 is a flowchart illustrating measurement processing that the ranging module performs to measure a distance to an object.

FIG. 14 is a block diagram illustrating a configuration example of an electronic apparatus to which the present technology is applied.

FIG. 15 is a block diagram depicting an example of schematic configuration of a vehicle control system.

FIG. 16 is a diagram of assistance in explaining an example of installation positions of an outside-vehicle information detecting section and an imaging section.

### DESCRIPTION OF EMBODIMENT

Now, a mode for embodying the present technology (hereinafter referred to as “embodiment”) is described. Note that the following items are described in order;

1. Configuration Example of Ranging Module;

2. Indirect ToF Ranging Method;

3. First Configuration Example of Illumination Device;

4. Second Configuration Example of Illumination Device;

5. Third Configuration Example of Illumination Device;

6. Measurement Processing by Ranging Module;

7. Configuration Example of Electronic Apparatus; and

8. Application Example to Moving Body

<1. Configuration Example of Ranging Module>

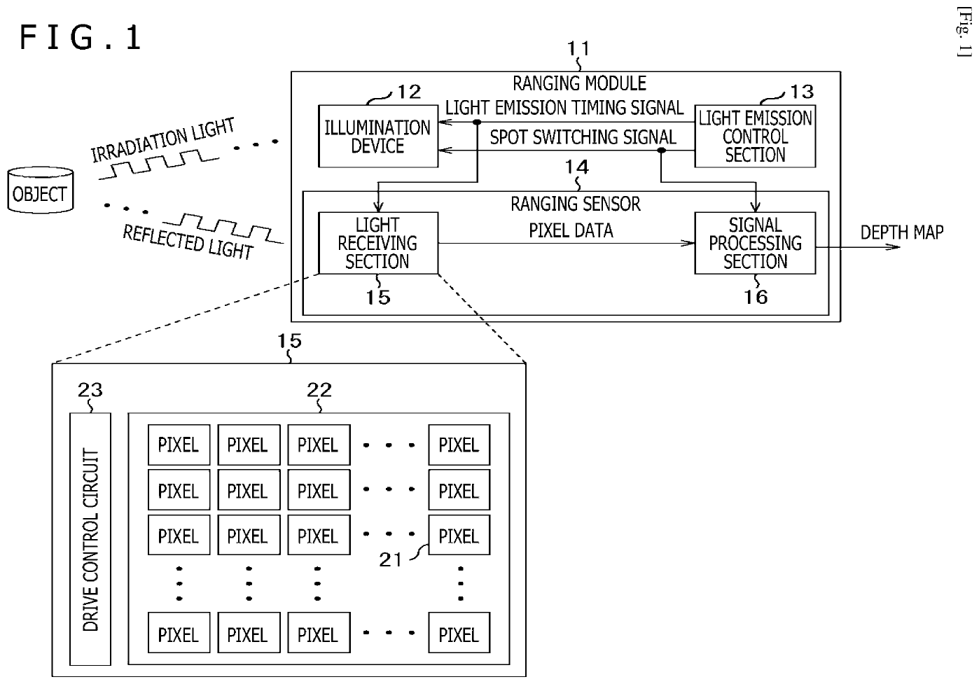

FIG. 1 is a block diagram illustrating a configuration example of a ranging module of one embodiment to which the present technology is applied.

A ranging module 11 illustrated in FIG. 1 may be, for example, a ranging module configured to perform Indirect ToF ranging, and may include an illumination device 12, a light emission control section 13, and a ranging sensor 14. The ranging module 11 applies light to an object and receives light that is the light (irradiation light) reflected by the object (reflected light), to thereby generate and output a depth map that is information regarding a distance to the object. The ranging sensor 14 is a light receiving device configured to receive reflected light, and includes a light receiving section 15 and a signal processing section 16.

The illumination device 12 is, for example, a device including a VCSEL array as a light source, and modulates and emits light at a timing depending on a light emission timing signal that is supplied from the light emission control section 13, to thereby apply the irradiation light to an object.

Further, the illumination device 12 switches spot irradiation and area irradiation depending on spot switching signals that are supplied from the light emission control section 13.

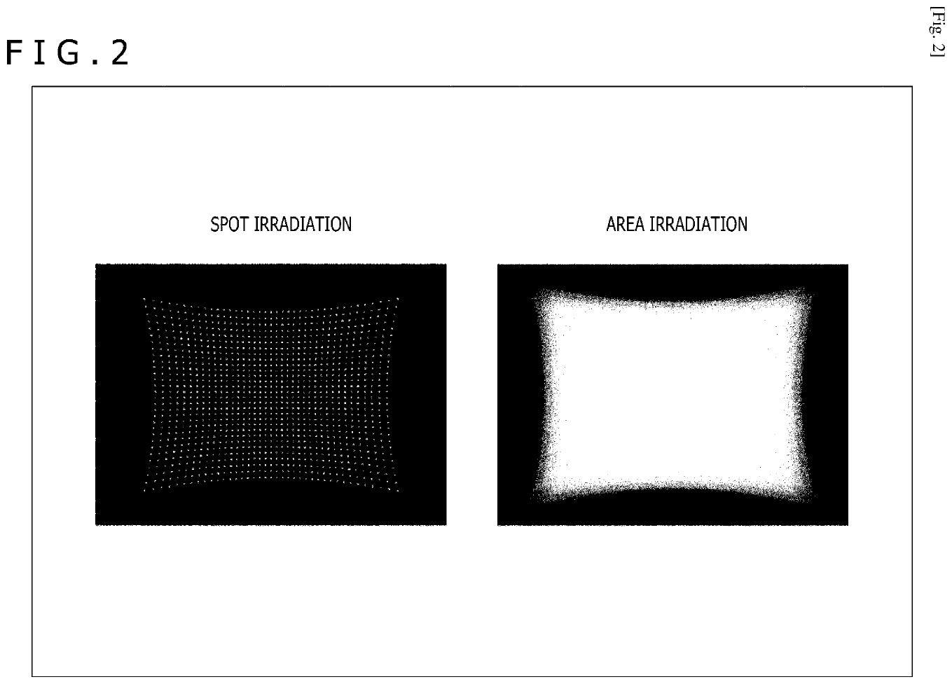

FIG. 2 is a diagram illustrating irradiation images of spot irradiation and area irradiation.

Spot irradiation is an irradiation method that applies light including a plurality of circular or oval spots regularly arrayed in accordance with predetermined rules. Area irradiation is an irradiation method that applies, to the whole of a predetermined substantially rectangular area, light having uniform luminance in a predetermined luminance range. In the following, light that is output by spot irradiation is also referred to as “spot light,” and light that is output by area irradiation is also referred to as “uniform light.”

The light emission control section 13 supplies, to the illumination device 12, light emission timing signals having a predetermined frequency (for example, 20 MHz) to control the light emission of the illumination device 12. Further, the light emission control section 13 also supplies light emission timing signals to the light receiving section 15, thereby driving the light receiving section 15 when the illumination device 12 emits light.

Moreover, the light emission control section 13 controls switching between spot irradiation and area irradiation. Specifically, the light emission control section 13 supplies spot switching signals indicating spot irradiation or area irradiation to the illumination device 12. Further, the light emission control section 13 also supplies spot switching signals to the signal processing section 16, thereby switching signal processing on the basis of the irradiation method.

The light receiving section 15 includes a pixel array section 22 including pixels 21 two-dimensionally arranged in matrix in the row direction and the column direction, and a drive control circuit 23 placed in the peripheral region of the pixel array section 22. The pixels 21 each generate charges depending on the light intensity of received light and output signals depending on the charges.

The light receiving section 15 receives reflected light from an object by the pixel array section 22 in which the plurality of pixels 21 is two-dimensionally arranged. Then the light receiving section 15 supplies, to the signal processing section 16, pixel data including detection signals depending on the reception light intensity of the reflected light that each of the pixels 21 of the pixel array section 22 has received.

The drive control circuit 23 generates control signals for controlling the drive of the pixels 21 on the basis of a light emission timing signal that is supplied from the light emission control section 13, for example, and supplies the control signal to each of the pixels 21. The drive control circuit 23 controls a light reception period in which each of the pixels 21 receives reflected light.

The signal processing section 16 calculates, for each of the pixels 21 of the pixel array section 22, a depth value that is a distance from the ranging module 11 to an object on the basis of pixel data that is supplied from the light receiving section 15. The signal processing section 16 generates a depth map storing the depth values as the pixel values of the pixels 21, and outputs the depth map to the outside of the module.

More specifically, the signal processing section 16 generates a first depth map in spot irradiation and a second depth map in area irradiation. The signal processing section 16 generates a depth map to be output from the two depth maps of the first depth map and the second depth map, and outputs the depth map. A first depth map in spot irradiation can be a depth map less affected by multipath, but is low in resolution in the planar direction since a region that is irradiated with the light is small. Meanwhile, with area irradiation, the resolution in the planar direction is high since a wide region can be irradiated with the light, but the effect of multipath is larger than that in spot irradiation using spot light. Accordingly, a final depth map may be generated from the two depth maps of a first depth map in spot irradiation and a second depth map in area irradiation such that a high-resolution depth map less affected by multipath can be generated. To change correction processing in depth map generation between spot irradiation and area irradiation, spot switching signals indicating spot irradiation or area irradiation are supplied to the signal processing section 16.

<2. Indirect ToF Ranging Method>

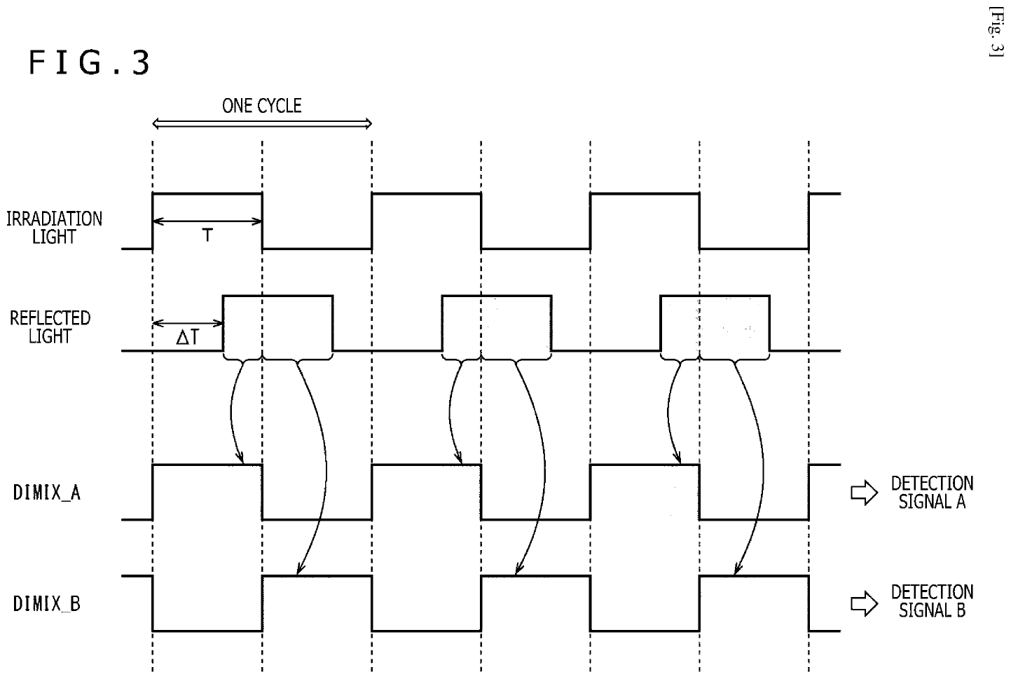

With reference to FIG. 3, an Indirect ToF distance measurement method is briefly described.

The illumination device 12 outputs spot light or uniform light modulated to repeatedly turn on and off irradiation at an irradiation time T (one cycle=2T) as illustrated in FIG. 3. The light receiving section 15 receives, as reflected light, the spot light or uniform light output from the illumination device 12 after a delay time ΔT depending on a distance to an object has elapsed.

Here, each of the pixels 21 of the pixel array section 22 includes a photodiode configured to perform photoelectric conversion on reflected light, and two charge accumulating sections configured to accumulate charges obtained as a result of photoelectric conversion by the photodiode. The charges obtained as a result of photoelectric conversion by the photodiode are distributed to the two charge accumulating sections with distribution signals DIMIX_A and DIMIX_B. The distribution signal DIMIX_A and the distribution signal DIMIX_B are signals having opposite phases.

The pixel 21 distributes charges generated by the photodiode to the two charge accumulating sections depending on the delay time ΔT, and outputs a detection signal A and a detection signal B depending on the accumulated charges. The ratio of the detection signal A and the detection signal B depends on the delay time ΔT, in other words, depends on a distance to an object. Thus, the ranging module 11 can obtain a distance to an object (depth value) on the basis of the detection signal A and detection signal B.

In the Indirect ToF method, a depth value d corresponding to a distance to an object can be obtained by Expression (1) below.

$$\begin{matrix}[ Math \text{.1} ] & \\ d = \frac{c \cdot Δ T}{2} = \frac{c \cdot ϕ}{4 π f} & ( 1 )\end{matrix}$$

In Expression (1), c represents light speed, ΔT represents delay time, and f represents light modulation frequency. Further, in Expression (1), φ represents reflected light phase shift amount [rad], which can be obtained from the ratio of the detection signal A and the detection signal B.

The outline of ranging by the ranging module 11 is described above. The ranging module 11 has a feature that the illumination device 12 having a simple configuration can switch spot irradiation and area irradiation depending on spot switching signals.

Now, the configuration of the illumination device 12 is described in detail. As the configuration of the illumination device 12, any one of first to third configuration examples described below can be employed.

<3. First Configuration Example of Illumination Device>

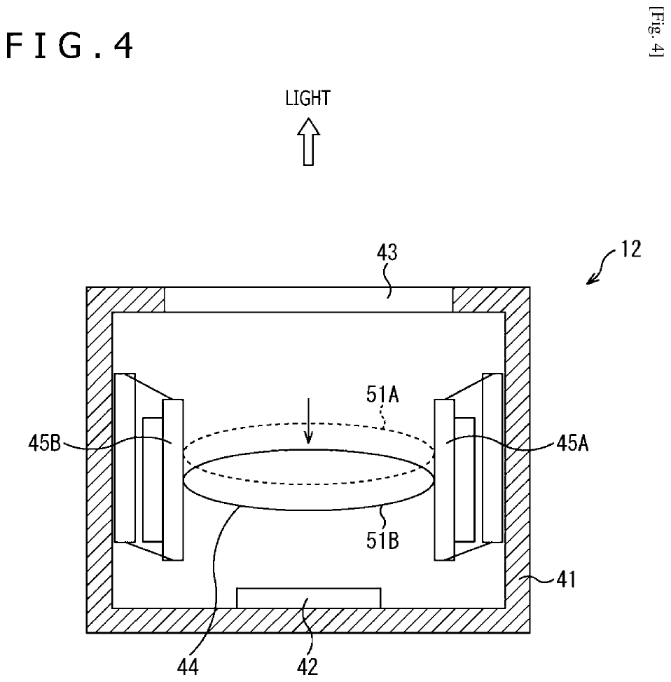

FIG. 4 is a sectional view illustrating the first configuration example of the illumination device 12.

The illumination device 12 includes a light emitting section 42 fixed to a predetermined surface of the inner peripheral surfaces of a casing 41 that is a hollow quadrangular prism, and a diffractive optical element 43 fixed to a surface facing the surface having the light emitting section 42 fixed thereto.

Further, the illumination device 12 includes a projection lens 44 and lens driving sections 45A and 45B. The lens driving sections 45A and 45B are fixed to two surfaces of the inner peripheral surfaces of the casing 41. The two surfaces face each other in a direction vertical to an optical axis direction connecting the light emitting section 42 and the diffractive optical element 43 to each other. The lens driving sections 45A and 45B move the projection lens 44 in the optical axis direction.

FIG. 4 is a sectional view when viewed from the direction vertical to the optical axis of light that is emitted from the light emitting section 42.

The light emitting section 42 includes a VCSEL array (light source array) in which a plurality of VCSELs (Vertical Cavity Surface Emitting Lasers), each of which is a light source, is planarly arrayed, for example, and repeatedly turns on and off light emission at a predetermined cycle depending on light emission timing signals from the light emission control section 13.

The diffractive optical element 43 duplicates, in the direction vertical to the optical axis direction, a light emission pattern (light emission surface) that has a predetermined region and has been emitted from the light emitting section 42 to pass through the projection lens 44, to thereby expand the irradiation area. Note that the diffractive optical element 43 is omitted in some cases. For example, in a case where the size of the VCSEL array, which serves as the light emitting section 42, is large, the diffractive optical element 43 is omitted.

The projection lens 44 projects light that is emitted from the light emitting section 42 to an object to be measured. The projection lens 44 is fixed to the lens driving sections 45A and 45B, and the lens driving sections 45A and 45B control the position of the projection lens 44 in the optical axis direction.

Specifically, in a case where a spot switching signal that is supplied from the light emission control section 13 indicates spot irradiation, the lens driving sections 45A and 45B control the projection lens 44 to be positioned at a first lens position 51A in the optical axis direction. In a case where a spot switching signal indicates area irradiation, the lens driving sections 45A and 45B control the projection lens 44 to be positioned at a second lens position 51B in the optical axis direction. The lens driving sections 45A and 45B include, for example, voice coil motors. The position of the projection lens 44 is shifted to the first lens position 51A or the second lens position 51B when a current that flows through the voice coils is turned on or off depending on spot switching signals. Note that the lens driving sections 45A and 45B may use piezoelectric elements instead of the voice coil motors to move the position of the projection lens 44 in the optical axis direction.

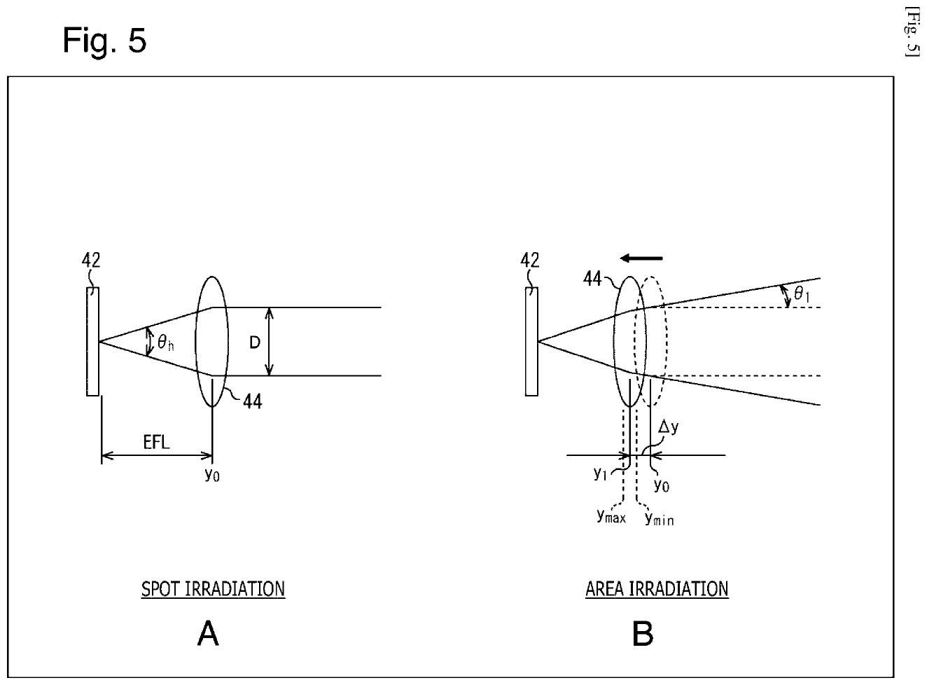

FIG. 5A and FIG. 5B depict sectional views illustrating the movement of the projection lens 44 in switching between spot irradiation and area irradiation.

The illumination device 12 performs spot irradiation in a case where a distance between the light emitting section 42 and the projection lens 44 is an effective focal length EFL [mm] of the projection lens 44.

Specifically, as illustrated in FIG. 5A, in a case where a position of the projection lens 44 in the optical axis direction is y₀, the distance from the light emitting section 42, which includes the VCSEL array, to the projection lens 44 is the effective focal length EFL of the projection lens 44, and the illumination device 12 thus performs spot irradiation to an object. In this case, the projection lens 44 functions as a collimator lens. The projection lens 44 converts light emitted from the light emitting section 42 at a divergence angle θₕ to parallel light (light flux) having a diameter D, and outputs the parallel light.

Meanwhile, the illumination device 12 performs area irradiation in a case where the distance between the light emitting section 42 and the projection lens 44 corresponds to a position y₁ that is closer to the light emitting section 42 by Δy than the position y₀ corresponding to the effective focal length EFL [mm] of the projection lens 44 is, as illustrated in FIG. 5B. In other words, the illumination device 12 moves the projection lens 44 to a position at which the projection lens 44 is out of focus to perform area irradiation. Light that is emitted from the projection lens 44 with the projection lens 44 being out of focus expands outward from the parallel light (light flux), which has the diameter D, by an angle θ₁. The angle θ₁ is referred to as “defocus divergence angle θ₁.”

The position y₀ of the projection lens 44 corresponds to the first lens position 51A in FIG. 4, and the position y₁ corresponds to the second lens position 51B in FIG. 4.

In the first configuration example, the lens driving sections 45A and 45B correspond to a switching section configured to change the focal length to switch spot irradiation and area irradiation, and change the position of the projection lens 44 to switch spot irradiation and area irradiation.

In the case where a spot switching signal that is supplied from the light emission control section 13 indicates spot irradiation, the current that flows through the lens driving sections 45A and 45B is reduced to zero and the projection lens 44 is controlled to the position y₀. In contrast, in the case where a spot switching signal that is supplied from the light emission control section 13 indicates area irradiation, the current that flows through the lens driving sections 45A and 45B takes a positive value and the projection lens 44 is controlled to the position y₁.

Note that the control theory can be reversed. Specifically, in the case where a spot switching signal indicates spot irradiation, the current that flows through the lens driving sections 45A and 45B may take a positive value and the projection lens 44 may be controlled to the position y₀. In the case where a spot switching signal indicates area irradiation, the current that flows through the lens driving sections 45A and 45B may be reduced to zero and the projection lens 44 may be shifted to the position y₁ through control.

To ensure uniform illumination in area irradiation, the lens driving sections 45A and 45B perform control such that the movement amount Δy from the position y₀ to the position y₁ falls within a range of from a lower limit value yₘᵢₙ to an upper limit value yₘₐₓ (yₘᵢₙ≤Δy≤yₘₐₓ).

Here, the lower limit value yₘᵢₙ and the upper limit value yₘₐₓ are a value represented by Expression (2) and a value represented by Expression (3), respectively.

$$\begin{matrix}[ Math \text{.2} ] & \\ {y}_{min} = EFL - \frac{EFL + sin ( {θ}_{h 1} / 2 )}{sin \{ \frac{A p / 2}{EFL} - \frac{A s / 2}{EFL} + {θ}_{h 1} \}} & ( 2 )\end{matrix}$$

$${y}_{max} = EFL - \frac{EFL + sin ( {θ}_{h 2} / 2 )}{sin \{ \frac{A p / 2}{EFL} - \frac{A s / 2}{EFL} + {θ}_{h 2} \}} \qquad ( 3 )$$

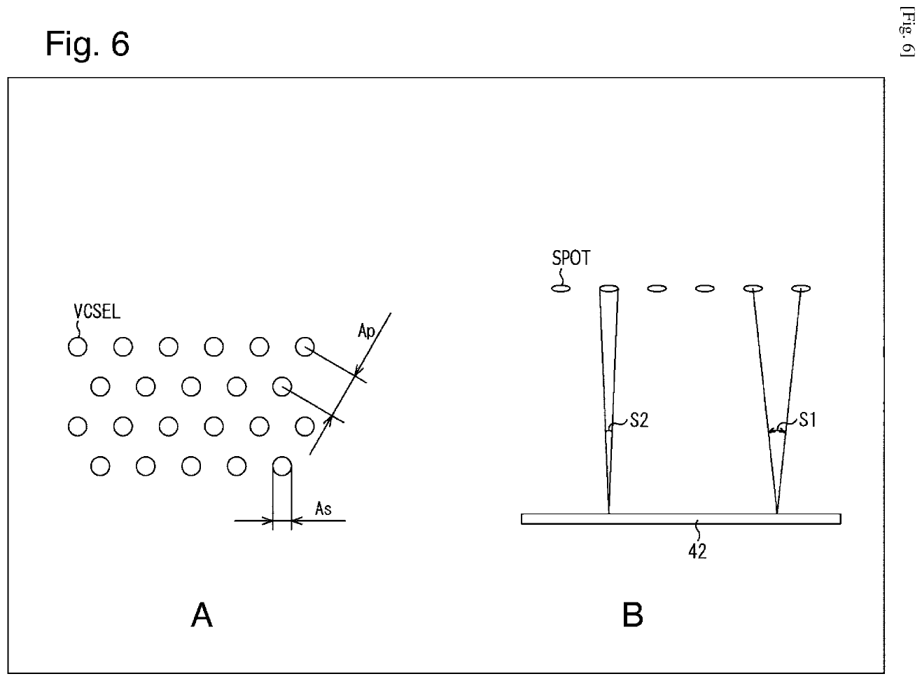

FIG. 6A and FIG. 6B depict views illustrating the parameters of As, Ap, θₕ₁, and θₕ₂ that are used for calculations in Expression (2) and Expression (3).

FIG. 6A is a plan view of part of the light emitting section 42, which includes the VCSEL array, when viewed from the optical axis direction. FIG. 6B is a plan view of a light flux that is emitted from each VCSEL of the light emitting section 42, the light flux being viewed from the direction vertical to the optical axis direction.

As illustrated in FIG. 6A, As denotes the opening size [mm] of each VCSEL of the light emitting section 42, which includes the VCSEL array, and Ap denotes a distance [mm] between the centers of the plurality of VCSELs arrayed in the planar direction (inter-light source distance). Thus, the light emitting section 42 is the VCSEL array in which the plurality of light sources (VCSELs) each configured to emit light with the opening size As is arrayed with the inter-light source distance Ap.

As illustrated in FIG. 6B, in spot irradiation, an angle [rad] formed by adjacent spots is denoted by S1, and an angle [rad] of a spot itself, which is formed by one VCSEL, is denoted by S2.

In Expression (2), θₕ₁ represents the divergence angle θₕ [rad] at which the ratio of the laser intensity of the far field pattern (FFP) of a VCSEL to the peak intensity is 45%. In Expression (3), θₕ₂ represents the divergence angle θₕ [rad] at which the ratio of the laser intensity of the far field pattern of a VCSEL to the peak intensity is 70%.

Next, a calculation method for the lower limit value yₘᵢₙ and the upper limit value yₘₐₓ, which are expressed by Expression (2) and Expression (3), is described.

In switching from spot irradiation to area irradiation, adjacent spot light beams are overlapped with each other to achieve area irradiation.

Specifically, as expressed by Expression (4) below, switching is performed such that the defocus divergence angle θ₁ in area irradiation takes an angle larger than an angle obtained by adding half of the angle S1 formed by adjacent spots (S1/2) and half of the angle S2 of a spot itself (S2/2) together. Area irradiation that uniformly applies light to planar regions can be achieved in this way.

$$\begin{matrix}[ Math \text{.3} ] & \\ {θ}_{1} > ( \frac{S 1}{2} + \frac{S 2}{2} ) & ( 4 )\end{matrix}$$

Here, S1/2 in Expression (4) can approximately be expressed by Expression (5) from the inter-light source distance Ap of the VCSEL array and the effective focal length EFL of the projection lens 44.

$$\begin{matrix}[ Math \text{.4} ] & \\ \frac{S 1}{2} {\dot{=}}_{\cdot } \frac{A p / 2}{EFL} & ( 5 )\end{matrix}$$

Further, S2/2 in Expression (4) can approximately be expressed by Expression (6) from the opening size As of a VCSEL and the effective focal length EFL of the projection lens 44.

$$\begin{matrix}[ Math \text{.5} ] & \\ \frac{S 2}{2} {\dot{=}}_{\cdot } \frac{A s / 2}{EFL} & ( 6 )\end{matrix}$$

Meanwhile, the defocus divergence angle θ₁ in area irradiation can be expressed by Expression (7) with the use of the movement amount Δy of the projection lens 44, the effective focal length EFL of the projection lens 44, the divergence angle θₕ [rad] at which the ratio [%] of the laser intensity of the far field pattern of a VCSEL to the peak intensity is a predetermined value, and the diameter D of parallel light.

$$\begin{matrix}[ Math \text{.6} ] & \\ {θ}_{1} = {sin}^{- 1} ( \frac{D / 2}{EFL - Δy} ) - {θ}_{h} & ( 7 )\end{matrix}$$

In Expression (7), D represents the diameter of a light flux collimated by the projection lens 44, and can be expressed by Expression (8).

[Math. 7]

D=2×EFL×sin(θₕ/2) (8)

From the relationships of from Expression (4) to Expression (8), the relationship of the movement amount Δy of the objective lens and the inter-light source distance Ap of the VCSEL array is obtained. Expression (9) is then obtained.

$$\begin{matrix}[ Math \text{.8} ] & \\ Δ y = EFL - \frac{EFL + sin ( {θ}_{h} / 2 )}{sin \{ \frac{A p / 2}{EFL} - \frac{A s / 2}{EFL} + {θ}_{h} \}} & ( 9 )\end{matrix}$$

With respect to Expression (9) obtained as described above, the lower limit value yₘᵢₙ in Expression (2) is a value when the divergence angle θₕ of a VCSEL is the divergence angle θₕ₁ at which the ratio of the laser intensity to the peak intensity is 45%.

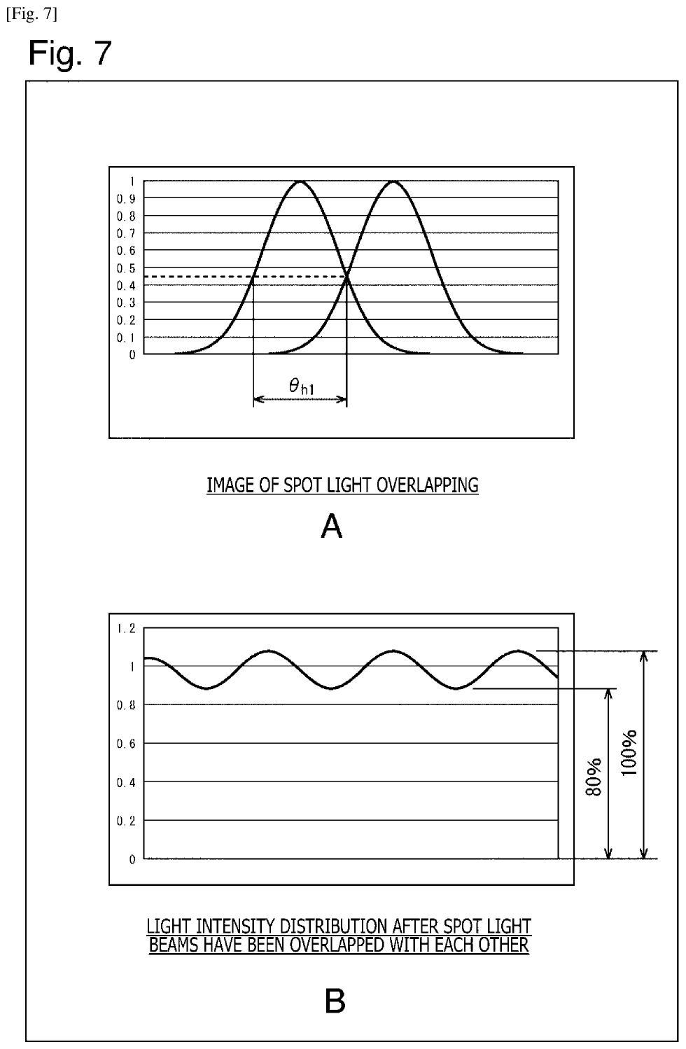

In the case where the divergence angle θₕ of a VCSEL is the divergence angle θₕ₁ at which the ratio of the laser intensity of the far field pattern of a VCSEL to the peak intensity is 45%, as in FIG. 7A, the spot light beams of adjacent VCSELs are overlapped with each other at a laser intensity of 45%. A light intensity distribution after the spot light beams of the VCSELs have been overlapped with each other is uniform at a laser intensity of from approximately 80 to 100% with respect to the peak intensity of each VCSEL as illustrated in FIG. 7B.

Meanwhile, with respect to Expression (9), the upper limit value yₘₐₓ in Expression (3) is a value when the divergence angle θₕ of a VCSEL is the divergence angle θₕ₂ at which the ratio of the laser intensity of the far field pattern of a VCSEL to the peak intensity is 70%.

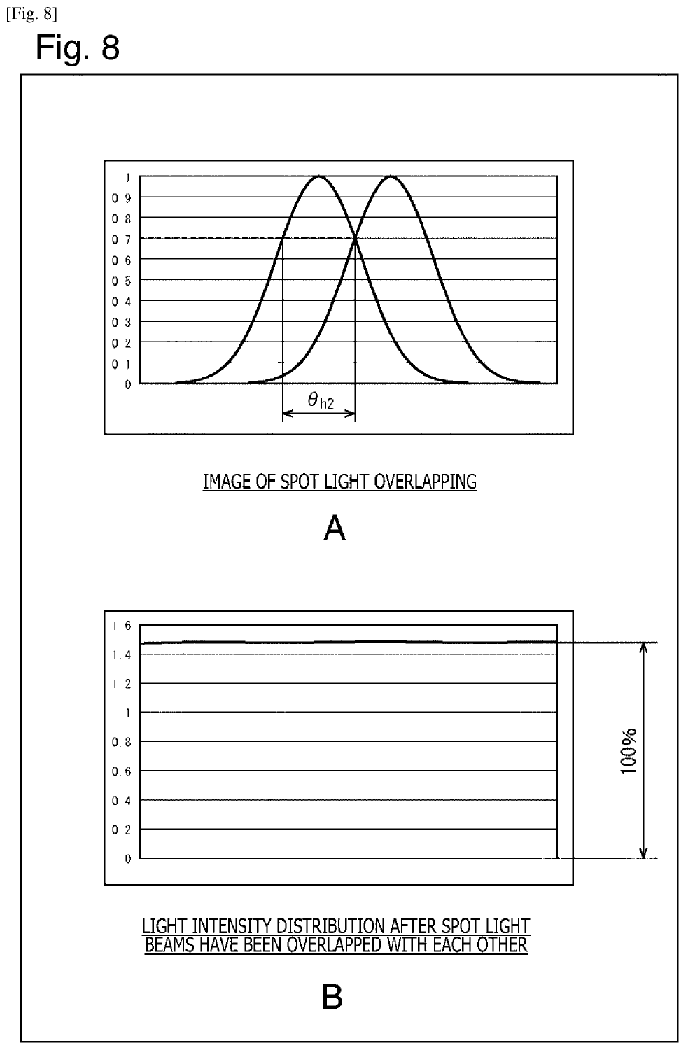

In the case where the divergence angle θₕ of a VCSEL is the divergence angle θₕ₂ at which the ratio of the laser intensity of the far field pattern of a VCSEL is 70%, as in FIG. 8A, the spot light beams of adjacent VCSELs are overlapped with each other at a laser intensity of 70%. A light intensity distribution after the spot light beams of the VCSELs have been overlapped with each other is uniform at a laser intensity of approximately 100% with respect to the peak intensity of each VCSEL as illustrated in FIG. 8B.

Thus with the movement amount Δy of the projection lens 44 set to a value between the lower limit value yₘᵢₙ in Expression (2) and the upper limit value yₘₐₓ in Expression (3), uniform light that has a laser intensity variation of 20% or less with respect to the peak intensity, and is thus uniform, can be applied. This prevents the occurrence of a partial reduction in laser intensity, thereby enabling a reduction in error of a measured distance at each ranging position in area irradiation.

In a case where the movement amount Δy of the projection lens 44 is smaller than the lower limit value yₘᵢₙ in Expression (2), the spot light overlapping portions are small and some of the overlapping portions have low light intensity, with the result that substantially uniform luminance is not obtained, leading to large distance errors at the low-light intensity portions.

In a case where the movement amount Δy of the projection lens 44 is larger than the upper limit value yₘₐₓ in Expression (3), under some conditions, the uniformity can be achieved with the laser intensity variation of 20% or less with respect to the peak intensity in area irradiation, but the movement amount Δy of the projection lens 44 is large.

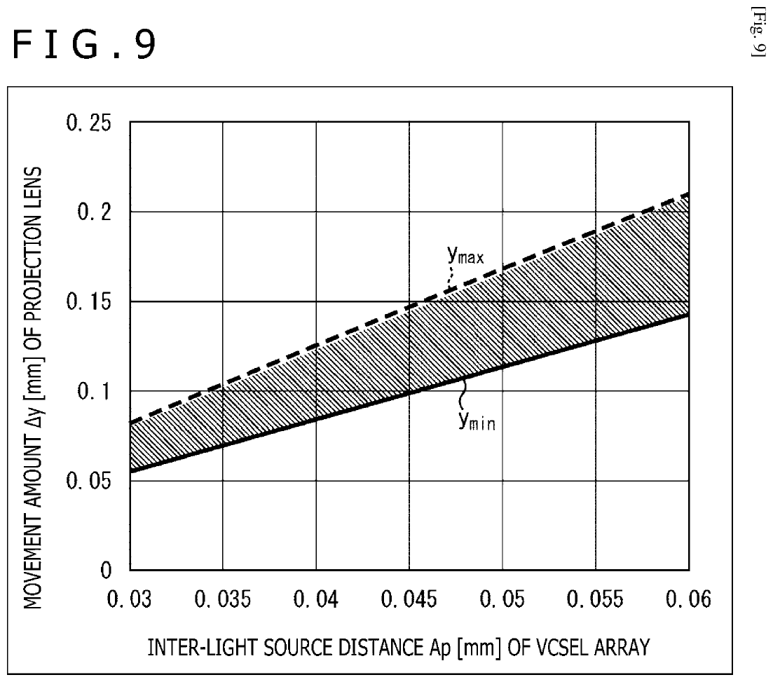

FIG. 9 is a graph in which the lower limit value yₘᵢₙ and the upper limit value yₘₐₓ of the movement amount Δy of the projection lens 44 when the inter-light source distance Ap of the VCSEL array is changed from 0.03 to 0.06 mm are plotted.

In FIG. 9, the horizontal axis indicates the inter-light source distance Ap of the VCSEL array, and the vertical axis indicates the movement amount Δy of the projection lens 44.

In FIG. 9, the lower limit value yₘᵢₙ and the upper limit value y_{mdx} are calculated, where the divergence angle θₕ₁ of a VCSEL corresponding to 45% of the peak intensity is 0.314 rad, the divergence angle θₕ₂ of a VCSEL corresponding to 70% of the peak intensity is 0.209 rad, the effective focal length EFL of the projection lens 44 is 2.5 mm, and the diameter D of the light flux of light emitted from a VCSEL to be collimated by the projection lens 44 is 0.012 mm.

In the calculation example illustrated in FIG. 9, for example, in a case where the inter-light source distance Ap of the VCSEL array is 45 μm, when the movement amount Δy of the projection lens 44 is set within a range of from approximately 0.1 mm or larger to 0.15 mm or smaller (0.1 mm≤Δy≤0.15 mm), light can be emitted by area irradiation with a uniformity of 80% or higher.

As described above, in the first configuration example, the lens driving sections 45A and 45B move the projection lens 44 by the movement amount Δy in area irradiation. At this time, the lens driving sections 45A and 45B perform control such that the movement amount Δy from the lens position (first lens position) y₀ for spot irradiation to the lens position (second lens position) y₁ for area irradiation falls within the range of from the lower limit value yₘᵢₙ to the upper limit value yₘₐₓ (yₘᵢₙ≤Δy≤yₘₐₓ) depending on the inter-light source distance Ap of the VCSEL array.

<4. Second Configuration Example of Illumination Device>

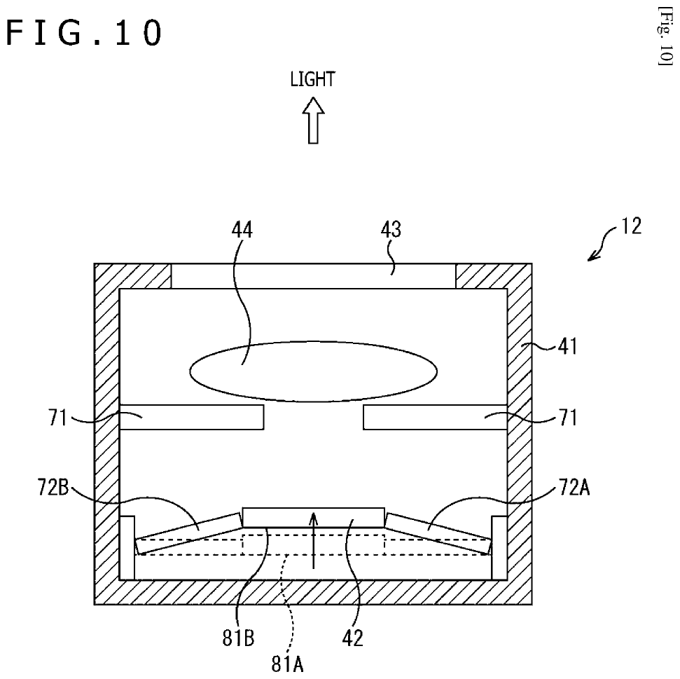

FIG. 10 is a sectional view illustrating the second configuration example of the illumination device 12.

The sectional view of FIG. 10 is a sectional view viewed from the direction vertical to the optical axis like FIG. 4 in the first configuration example.

In FIG. 10, parts corresponding to the parts of the first configuration example illustrated in FIG. 4 are denoted by the same reference symbols, and the description thereof is omitted appropriately.

In the configuration of the first configuration example illustrated in FIG. 4, the projection lens 44 is moved in the optical axis direction to change the distance between the VCSEL array, which is the light emitting section 42, and the projection lens 44, to thereby switch spot irradiation and area irradiation.

In contrast to this, in the second configuration example illustrated in FIG. 10, the VCSEL array, which is the light emitting section 42, is moved in the optical axis direction to change the distance between the VCSEL array, which is the light emitting section 42, and the projection lens 44.

Specifically, the projection lens 44 is fixed to a lens fixing member 71 and the lens fixing member 71 is fixed to the casing 41. With this the projection lens 44 is immovable.

Meanwhile, the light emitting section 42 is fixed to light source driving sections 72A and 72B, and the light source driving sections 72A and 72B control the position of the light emitting section 42 in the optical axis direction.

Specifically, in the case where a spot switching signal that is supplied from the light emission control section 13 indicates spot irradiation, the light source driving sections 72A and 72B control the light emitting section 42 to be positioned at a first light source position 81A in the optical axis direction. In the case where a spot switching signal indicates area irradiation, the light source driving sections 72A and 72B control the light emitting section 42 to be positioned at a second light source position 81B in the optical axis direction. The light source driving sections 72A and 72B include, for example, voice coil motors. The position of the light emitting section 42 is shifted to the first light source position 81A or the second light source position 81B when a current that flows through the voice coils is turned on or off depending on spot switching signals. Note that the lens driving sections 45A and 45B may use piezoelectric elements instead of the voice coil motors to move the position of the light emitting section 42 in the optical axis direction.

In the second configuration example, the light source driving sections 72A and 72B correspond to a switching section configured to change the focal length to switch spot irradiation and area irradiation, and change the position of the light emitting section 42 to switch spot irradiation and area irradiation.

In the case where a spot switching signal that is supplied from the light emission control section 13 indicates spot irradiation, the current that flows through the light source driving sections 72A and 72B is reduced to zero and the light emitting section 42 is controlled to be positioned at the first light source position 81A in the optical axis direction. In contrast, in the case where a spot switching signal that is supplied from the light emission control section 13 indicates area irradiation, the current that flows through the light source driving sections 72A and 72B takes a positive value and the light emitting section 42 is controlled to be positioned at the second light source position 81B in the optical axis direction.

Note that the control theory can be reversed. Specifically, in the case where a spot switching signal indicates spot irradiation, the current that flows through the light source driving sections 72A and 72B may take a positive value and the light emitting section 42 may be controlled to be positioned at the first light source position 81A in the optical axis direction. In the case where a spot switching signal indicates area irradiation, the current that flows through the light source driving sections 72A and 72B may be reduced to zero and the light emitting section 42 may be shifted to be positioned at the second light source position 81B in the optical axis direction through control.

In the case where the position of the light emitting section 42 in the optical axis direction is the first light source position 81A, the distance between the projection lens 44 and the light emitting section 42 is the effective focal length EFL of the projection lens 44. In the case where the position of the light emitting section 42 in the optical axis direction is the second light source position 81B, the distance between the projection lens 44 and the light emitting section 42 is a distance shorter than the effective focal length EFL of the projection lens 44 by the movement amount Δy with respect to the projection lens 44. To ensure uniform illumination in area irradiation, the light source driving sections 72A and 72B perform control such that the movement amount Δy falls within the range of from the lower limit value yₘᵢₙ to the upper limit value yₘₐₓ(yₘᵢₙ≤Δy≤yₘₐₓ) The lower limit value yₘᵢₙ and the upper limit value yₘₐₓ are expressed by Expression (2) and Expression (3) as in the first configuration example.

As described above, in the second configuration example the light source driving sections 72A and 72B move the light emitting section 42 by the movement amount Δy in area irradiation. At this time, the light source driving sections 72A and 72B perform control such that the movement amount Δy from the first light source position 81A for spot irradiation to the second light source position 81B for area irradiation falls within the range of from the lower limit value yₘᵢₙ to the upper limit value yₘₐₓ (yₘᵢₙ≤Δy≤yₘₐₓ) depending on the inter-light source distance Ap of the VCSEL array.

<5. Third Configuration Example of Illumination Device>

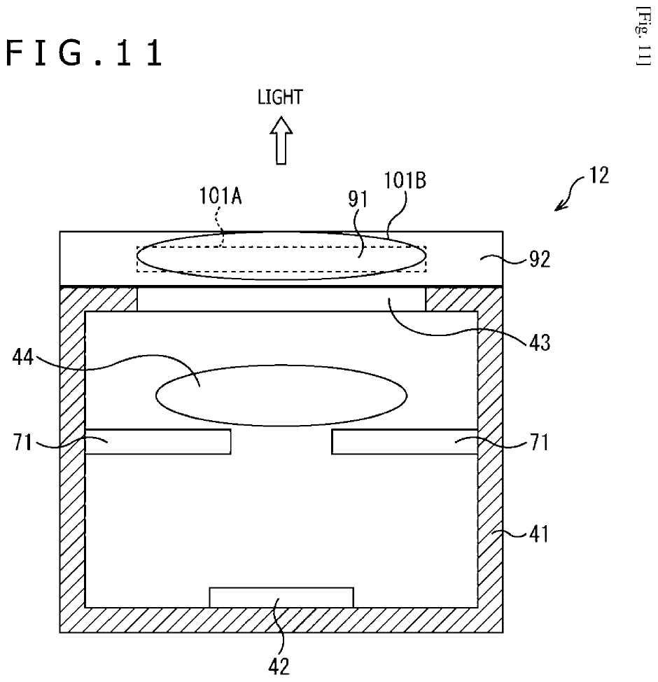

FIG. 11 is a sectional view illustrating the third configuration example of the illumination device 12.

The sectional view of FIG. 11 is a sectional view viewed from the direction vertical to the optical axis like FIG. 4 in the first configuration example.

In FIG. 11, parts corresponding to the parts of the first or second configuration example described above are denoted by the same reference symbols, and the description thereof is omitted appropriately.

In the configuration of the first or second configuration example, any one of the light emitting section 42 and the projection lens 44 is moved in the optical axis direction to change the focal length, to thereby switch spot irradiation and area irradiation. Note that in a modified example of the first and second configuration examples, both the light emitting section 42 and the projection lens 44 may be moved in the optical axis direction to control the movement amount Δy.

In contrast to this, in the third configuration example illustrated in FIG. 11 the light emitting section 42 is directly fixed to the casing 41 and the projection lens 44 is fixed to the casing 41 through the lens fixing member 71. The light emitting section 42 and the projection lens 44 are both immovable.

In the third configuration example, a lens fixing section 92 having a variable focus lens 91 mounted thereon is further provided on the front surface (light emission sidesurface) of the diffractive optical element 43. Light emitted from the light emitting section 42 passes through the projection lens 44, the diffractive optical element 43, and the variable focus lens 91 to be applied to an object.

The variable focus lens 91 may be a lens whose lens shape can be changed. For example, the variable focus lens 91 may be an elastic film filled with a fluid such as silicone oil or water, and is deformed by receiving pressure from a voice coil motor. Alternatively, the shape of the lens material of the variable focus lens 91 can be changed by applying high voltage to the lens material or applying voltage to the piezoelectric material. When the shape of the lens material is changed, the focal length can be changed. Alternatively, the refractive index of the liquid crystal layer of the variable focus lens 91 can be changed by applying voltage to a liquid crystal sealed in the lens material and the focal length can thus be changed.

More specifically, in the case where a spot switching signal that is supplied from the light emission control section 13 indicates spot irradiation, the variable focus lens 91 is controlled to take the lens shape of a first shape 101A. In the case where a spot switching signal indicates area irradiation, the variable focus lens 91 is controlled to take the lens shape of a second shape 101B.

In the case where the lens shape of the variable focus lens 91 is the first shape 101A, the refractive power (power) of the lens is zero or negative. Meanwhile, in the case where the lens shape of the variable focus lens 91 is the second shape 101B, the refractive power (power) of the lens is positive.

The variable focus lens 91 corresponds to a switching section configured to change the shape (curvature) or refractive index of the lens to control the refractive power of the lens to thereby switch spot irradiation and area irradiation.

In the case where a spot switching signal that is supplied from the light emission control section 13 indicates spot irradiation, a current that flows through the variable focus lens 91 is reduced to zero and the variable focus lens 91 is controlled to the first shape 101A corresponding to a refractive power of zero. In contrast, in the case where a spot switching signal that is supplied from the light emission control section 13 indicates area irradiation, the current that flows through the variable focus lens 91 takes a positive value and the variable focus lens 91 is controlled to the second shape 101B corresponding to a refractive power having a positive value larger than zero.

Note that the control theory can be reversed. Specifically, in the case where a spot switching signal indicates spot irradiation, the current that flows through the variable focus lens 91 may take a positive value and the variable focus lens 91 may be controlled to the first shape 101A. In the case where a spot switching signal indicates area irradiation, the current that flows through the variable focus lens 91 may be reduced to zero and the variable focus lens 91 may be controlled to the second shape 101B.

To ensure uniform illumination in area irradiation, the variable focus lens 91 is controlled such that a refractive power (power) Yₚ of the lens falls within a range of from a lower limit value Yₚₘᵢₙ to an upper limit value Yₚₘₐₓ (Yₚₘₘ≤Yₚ≤Yₚₘₐₓ).

Here, the lower limit value Yₚₘᵢₙ and the upper limit value Yₚₘₐₓ take a value represented by Expression (10) and a value represented by Expression (11), respectively.

$$\begin{matrix}[ Math \text{.9} ] & \\ {Y}_{p min} = \{ \frac{EFL + sin ( {θ}_{h = 45 \%} / 2 )}{EFL - sin ( \frac{A p / 2}{EFL} - \frac{A s / 2}{EFL} + {θ}_{h} )} \} \times \frac{A}{{EFL}^{2}} & ( 10 )\end{matrix}$$

$${Y}_{p {max}^{=}} \{ \frac{EFL + sin ( {θ}_{h = 70 \%} / 2 )}{EFL - sin ( \frac{A p / 2}{EFL} - \frac{A s / 2}{EFL} + {θ}_{h} )} \} \times \frac{A}{{EFL}^{2}} \qquad ( 11 )$$

In Expression (10) and Expression (11), θ_{h=45%} represents the divergence angle θₕ [rad] at which the ratio of the laser intensity of the far field pattern of a VCSEL to the peak intensity is 45%, and θ_{h=70%} represents the divergence angle θₕ [rad] at which the ratio of the laser intensity of the far field pattern of a VCSEL to the peak intensity is 70%. Further, A/EFL² represents a coefficient that is used in conversion to the refractive power (power) of the lens, and A represents a predetermined constant.

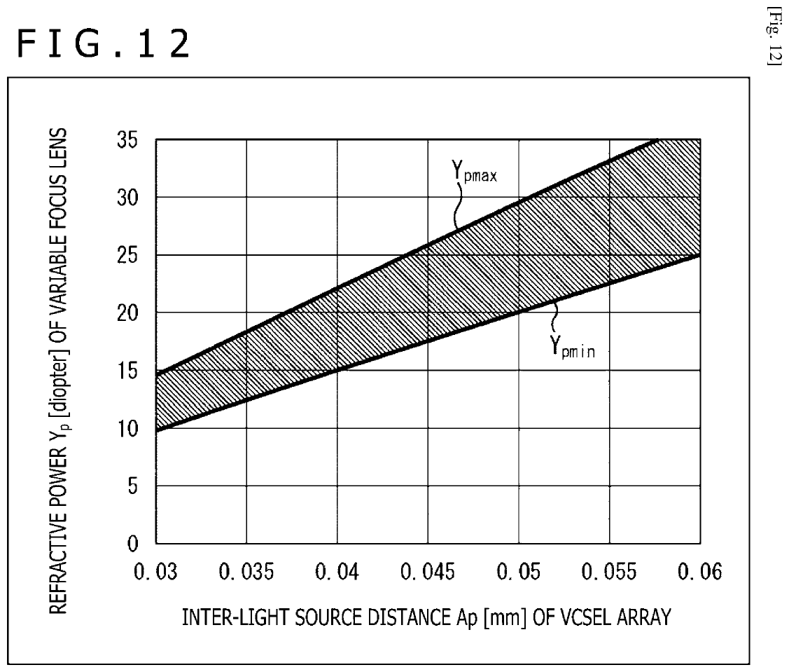

FIG. 12 is a graph in which the lower limit value Yₚₘᵢₙ and the upper limit value Yₚₘₐₓ of the refractive power Yₚ of the variable focus lens 91 when the inter-light source distance Ap of the VCSEL array is changed from 0.03 to 0.06 mm are plotted.

In FIG. 12, the horizontal axis indicates the inter-light source distance Ap of the VCSEL array, and the vertical axis indicates the refractive power Yₚ of the variable focus lens 91.

In FIG. 12, the lower limit value Yₚₘᵢₙ and the upper limit value Yₚₘₐₓ are calculated, where the divergence angle θ_{h=45%} of a VCSEL corresponding to 45% of the peak intensity is 0.314 rad, the divergence angle θ_{h=70%} of a VCSEL corresponding to 70% of the peak intensity is 0.209 rad, the effective focal length EFL of the projection lens 44 is 2.5 mm, the diameter D of the light flux of light emitted from a VCSEL to be collimated by the projection lens 44 is 0.012 mm, and the constant A is 1093.3.

In the calculation example illustrated in FIG. 12, for example, in the case where the inter-light source distance Ap of the VCSEL array is 45 μm, when the refractive power Yₚ of the variable focus lens 91 is set within a range of from approximately 17.5 diopter or larger to 26 diopter or smaller (0.1 mm≤Δy≤0.15 mm), light can be emitted by area irradiation with a uniformity of 80% or higher.

As described above, in the third configuration example, the variable focus lens 91 changes the shape (curvature) or refractive index of the lens in area irradiation. At this time the variable focus lens 91 controls the shape (curvature) or refractive index of the lens such that the refractive power Yₚ of the lens falls within the range of from the lower limit value Yₚₘᵢₙ to the upper limit value Yₚₘₐₓ (Yₚₘᵢₙ≤Yₚ≤Yₚₘₐₓ).

<6. Measurement Processing by Ranging Module>

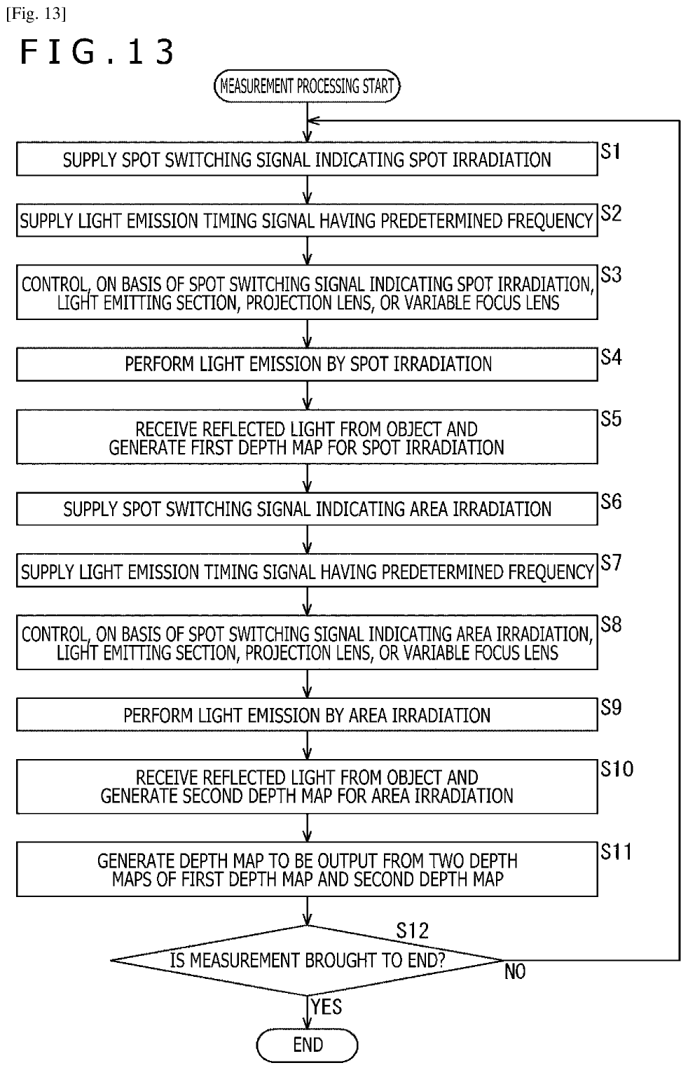

With reference to the flowchart of FIG. 13, measurement processing that the ranging module 11 performs to measure a distance to an object is described.

This processing starts when measurement start is instructed by, for example, the control unit of a host device incorporating the ranging module 11.

First, in Step S1, the light emission control section 13 supplies a spot switching signal indicating spot irradiation to the illumination device 12 and the signal processing section 16.

In Step S2, the light emission control section 13 supplies a light emission timing signal having a predetermined frequency (for example, 20 MHz) to the illumination device 12 and the light receiving section 15.

In Step S3, the illumination device 12 controls, on the basis of the spot switching signal indicating spot irradiation from the light emission control section 13, the light emitting section 42, the projection lens 44, or the variable focus lens 91. Specifically, in a case where the illumination device 12 is configured as the first configuration example illustrated in FIG. 4, the lens position of the projection lens 44 is shifted to the first lens position 51A through control. In a case where the illumination device 12 is configured as the second configuration example illustrated in FIG. 10, the light source position of the light emitting section 42 is shifted to the first light source position 81A through control. In a case where the illumination device 12 is configured as the third configuration example illustrated in FIG. 11, the lens shape of the variable focus lens 91 is changed to the first shape 101A, which corresponds to a refractive power of zero, through control.

In Step S4, the illumination device 12 controls the light emitting section 42 to emit light on the basis of the light emission timing signal from the light emission control section 13, to thereby apply the irradiation light to an object. With this, the illumination device 12 performs light emission by spot irradiation.

In Step S5, the ranging sensor 14 receives reflected light that is the irradiation light in spot irradiation reflected by the object, and generates a first depth map in spot irradiation.

More specifically, each of the pixels 21 of the light receiving section 15 receives the reflected light from the object under control of the drive control circuit 23. Each of the pixels 21 outputs the detection signal A and the detection signal B, which have been obtained by distributing charges generated by the photodiode to the two charge accumulating sections depending on the delay time ΔT, to the signal processing section 16 as pixel data. The signal processing section 16 calculates, for each of the pixels 21 of the pixel array section 22, a depth value that is a distance from the ranging module 11 to the object on the basis of the pixel data that is supplied from the light receiving section 15, to thereby generate a depth map storing the depth values as the pixel values of the pixels 21. The signal processing section 16 has received the spot switching signal indicating spot irradiation in the processing in Step S3. Thus, the signal processing section 16 executes depth map generation processing corresponding to spot irradiation to generate the first depth map.

In Step S6, the light emission control section 13 supplies a spot switching signal indicating area irradiation to the illumination device 12 and the signal processing section 16.

In Step S7, the light emission control section 13 supplies a light emission timing signal having a predetermined frequency to the illumination device 12 and the light receiving section 15. In a case where the light emission timing signal is continuously supplied in and after the processing in Step S2, the processing in Step S7 is omitted.

In Step S8, the illumination device 12 controls, on the basis of the spot switching signal indicating area irradiation from the light emission control section 13, the light emitting section 42, the projection lens 44, or the variable focus lens 91. Specifically, in the case where the illumination device 12 is configured as the first configuration example illustrated in FIG. 4, the lens position of the projection lens 44 may be shifted to the second lens position 51B through control. In the case where the illumination device 12 is configured as the second configuration example illustrated in FIG. 10, the light source position of the light emitting section 42 may be shifted to the second light source position 81B through control. In the case where the illumination device 12 is configured as the third configuration example illustrated in FIG. 11, the lens shape of the variable focus lens 91 may be changed to the second shape 101B, which corresponds to a refractive power having a positive value larger than zero, through control.

In Step S9, the illumination device 12 controls the light emitting section 42 to emit light on the basis of the light emission timing signal from the light emission control section 13, to thereby apply the irradiation light to the object. With this, the illumination device 12 performs light emission by area irradiation.

In Step S10, the ranging sensor 14 receives reflected light that is the irradiation light in area irradiation reflected by the object, and generates a second depth map in area irradiation. The signal processing section 16 has received the spot switching signal indicating area irradiation in the processing in Step S6. Thus, the signal processing section 16 executes depth map generation processing corresponding to area irradiation to generate the second depth map.

In Step S11, the signal processing section 16 generates a depth map to be output from the two depth maps of the first depth map in spot irradiation and the second depth map in area irradiation, and outputs the depth map.

In Step S12, the ranging module 11 determines whether to end measurement or not. For example, in a case where an order for ending measurement has been supplied from the host device, the ranging module 11 determines to end measurement.

In a case where it is determined that measurement is not brought to an end (i.e., measurement is continued) in Step S12, the processing returns to Step S1, and the processing in Steps S1 to S12 described above is repeated. Meanwhile, in a case where it is determined that measurement is brought to an end in Step S12, the measurement processing in FIG. 13 ends.

Note that in the processing described above, depth map generation based on spot irradiation is executed first, and then depth map generation based on area irradiation is executed. This order may be reversed. Specifically, depth map generation based on area irradiation may be executed first, and then depth map generation based on spot irradiation may be executed.

With the measurement processing described above, the ranging module 11 switches spot irradiation and area irradiation, and generates the two depth maps of a first depth map in spot irradiation and a second depth map in area irradiation. Then the ranging module 11 generates a final depth map to be output from the two depth maps of the first depth map and the second depth map. With this, a high-resolution depth map can be generated while the effect of multipath is reduced.

The ranging module 11 can achieve both spot irradiation (spot illumination) and area irradiation (area illumination) with one illumination unit. Specifically, with control by the illumination device 12, which is one illumination device, on the light emitting section 42, the projection lens 44, or the variable focus lens 91, both spot irradiation and area irradiation can be achieved. This can contribute to reductions in size and price of the illumination device 12.

<7. Configuration Example of Electronic Apparatus>

The ranging module 11 described above can be installed on an electronic apparatus, for example, a smartphone, a tablet terminal, a mobile phone, a personal computer, a game console, a television receiver, a wearable terminal, a digital still camera, or a digital video camera.

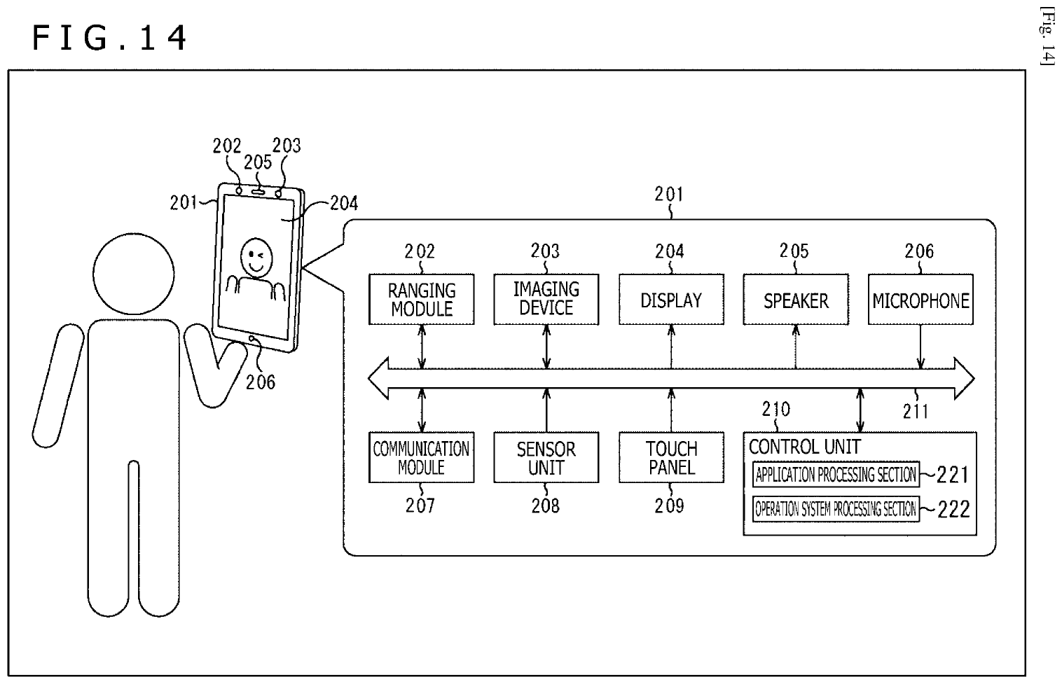

FIG. 14 is a block diagram illustrating a configuration example of a smartphone serving as an electronic apparatus having a ranging module installed thereon.

As illustrated in FIG. 14, a smartphone 201 includes a ranging module 202, an imaging device 203, a display 204, a speaker 205, a microphone 206, a communication module 207, a sensor unit 208, a touch panel 209, and a control unit 210 that are connected to each other through a bus 211. Further, the control unit 210 functions as an application processing section 221 and an operation system processing section 222 with a CPU executing programs.

The ranging module 11 in FIG. 1 is applied to the ranging module 202. For example, the ranging module 202 is placed on the front surface of the smartphone 201. The ranging module 202 performs ranging targeted at a user of the smartphone 201, thereby being capable of outputting, as a ranging result, the depth value of the surface shape of the face, hand, finger, or the like of the user.

The imaging device 203 is placed on the front surface of the smartphone 201 and captures the image of an object being the user of the smartphone 201 to acquire an image in which the user appears. Note that although not illustrated, the imaging device 203 may also be placed on the back surface of the smartphone 201.

The display 204 displays operation screens for performing processing by the application processing section 221 and the operation system processing section 222, images captured by the imaging device 203, or the like. When a call is made using the smartphone 201, for example, the speaker 205 and the microphone 206 output voice of the other person and collect voice of the user.

The communication module 207 performs communication via a communication network. The sensor unit 208 senses speed, acceleration, proximity, or the like. The touch panel 209 acquires touch operation by the user on an operation screen displayed on the display 204.

The application processing section 221 performs processing for providing various kinds of service by the smartphone 201. For example, the application processing section 221 can perform the processing of creating, using computer graphics, a face virtually reproducing the user's facial expression on the basis of a depth map that is supplied from the ranging module 202, and controlling the display 204 to display the face. Further, the application processing section 221 can perform, for example, the processing of creating three-dimensional shape data of any stereoscopic object on the basis of a depth map that is supplied from the ranging module 202.

The operation system processing section 222 performs processing for implementing basic functions and operation of the smartphone 201. For example, the operation system processing section 222 can perform the processing of authenticating the face of the user on the basis of a depth map that is supplied from the ranging module 202 and unlocking the smartphone 201. Further, the operation system processing section 222 can perform, for example, the processing of recognizing the gesture of the user on the basis of a depth map that is supplied from the ranging module 202 and inputting various kinds of operation based on the gesture.

With the application of the ranging module 11 including the illumination device 12 reduced in size and price, the smartphone 201 configured in such a way can more accurately detect ranging information while reducing the installation area of the ranging module 11, for example.

<8. Application Example to Moving Body>

The technology according to the present disclosure (present technology) is applicable to various products. For example, the technology according to the present disclosure may be realized as a device that is mounted on any type of moving body such as automobiles, electric vehicles, hybrid electric vehicles, motorcycles, bicycles, personal mobilities, airplanes, drones, ships, and robots.

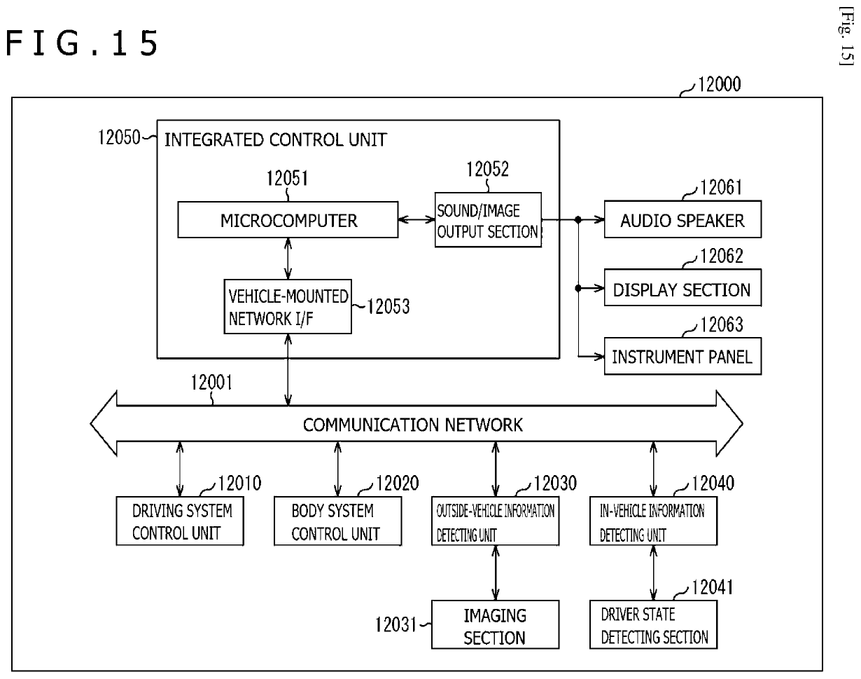

FIG. 15 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 15, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 15, an audio speaker 12061, a display section 12062, and an instrument panel 12063 are illustrated as the output device. The display section 12062 may, for example, include at least one of an on-board display and a head-up display.

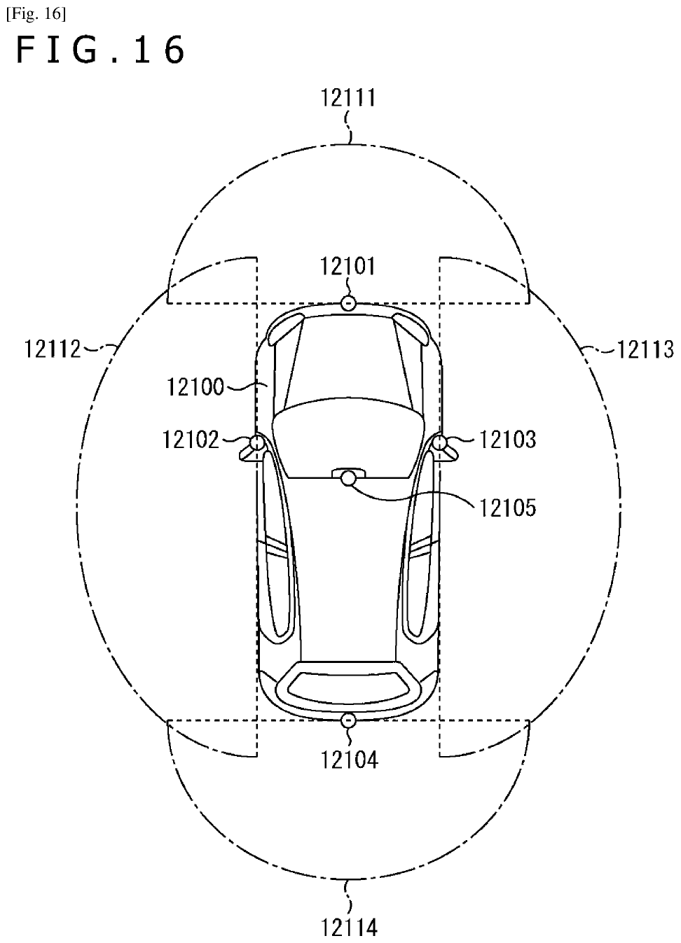

FIG. 16 is a diagram depicting an example of the installation position of the imaging section 12031.

In FIG. 16, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 16 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the outside-vehicle information detecting unit 12030 or the in-vehicle information detecting unit 12040 among the above-mentioned configurations. Specifically, with the use of ranging by the ranging module 11 in the outside-vehicle information detecting unit 12030 or the in-vehicle information detecting unit 12040, the processing of recognizing the gesture of a driver is performed so that operation of various devices (for example, audio system, navigation system, and air conditioning system) based on the gesture is executed or the driver's condition can be more accurately detected. Further, with the use of ranging by the ranging module 11, road surface unevenness can be recognized so as to be reflected in suspension control, for example. With the application of the ranging module 11 including the illumination device 12 reduced in size and price, ranging information can be more accurately detected while the installation area of the ranging module 11 is reduced.

Note that the technology according to the present disclosure may be applied to direct ToF ranging modules or Structured Light ranging modules other than Indirect ToF ranging modules. Besides, the technology according to the present disclosure is applicable to any illumination device configured to switch spot irradiation and area irradiation.

The embodiment of the present technology is not limited to the embodiment described above, and various modifications can be made within the scope of the gist of the present technology.

The plurality of present technologies described herein can be implemented independently of each other as long as no contradiction arises. As a matter of course, the plurality of present technologies can be implemented in any combination. For example, part or whole of the present technology described in any embodiment can be implemented in combination with part or whole of the present technology described in another embodiment. Further, part or whole of any present technology described above can be implemented in combination with another technology not described above.

Further, for example, the configuration described as one device (or processing unit) may be divided into a plurality of devices (or processing units). In contrast, the configurations described above as the plurality of devices (or processing units) may be put in one device (or processing unit). Further, a configuration other than the ones described above may be added to the configuration of each device (or each processing unit) as a matter of course. Moreover, as long as the configuration and operation of the entire system is substantially the same, the configuration of a certain device (or processing unit) may be partly included in the configuration of another device (or another processing unit).

Moreover, herein, “system” means an aggregation of a plurality of components (device, module (part), or the like), and it does not matter whether or not all of the components are in the same cabinet. Thus, a plurality of devices that are accommodated in separate cabinets and connected to each other via a network, and one device including a plurality of modules accommodated in one cabinet are both “system.”

Further, for example, the programs described above can be executed by any device. In such a case, it is sufficient that the device has desirable functions (functional blocks, for example) and can thus acquire desirable information.

Note that the effects described herein are merely exemplary and are not limited, and effects other than the ones described herein may be provided.

Note that the present technology can take the following configurations.

(1)

An illumination device, including:

a light emitting section;

a projection lens configured to project light that is emitted from the light emitting section; and

a switching section configured to change a focal length to switch spot irradiation and area irradiation.

(2)

The illumination device according to Item (1),

in which the switching section moves the projection lens to a position at which the projection lens is out of focus, thereby performing area irradiation.

(3)

The illumination device according to Item (1) or (2),

in which the switching section includes a lens driving section configured to control a position of the projection lens, and

the lens driving section changes the position of the projection lens, thereby switching spot irradiation and area irradiation.

(4)

The illumination device according to Item (3),

in which the light emitting section includes a light source array in which a plurality of light sources each configured to emit light with a predetermined opening size are arrayed with a predetermined inter-light source distance.

(5)

The illumination device according to Item (4),

in which the lens driving section controls the position of the projection lens such that a movement amount from a first lens position for spot irradiation to a second lens position for area irradiation takes a value equal to or larger than a predetermined lower limit value depending on the predetermined inter-light source distance.

(6)

The illumination device according to Item (5),

in which the following expression is satisfied:

$$\begin{matrix}[ Math \text{.10} ] & \\ {y}_{min} = EFL - \frac{EFL + sin ( {θ}_{h 1} / 2 )}{sin \{ \frac{A p / 2}{EFL} - \frac{A s / 2}{EFL} + {θ}_{h 1} \}} & \end{matrix}$$

where yₘᵢₙ represents the predetermined lower limit value, EFL represents an effective focal length of the projection lens, Ap represents the predetermined inter-light source distance, As represents the predetermined opening size, and θₕ₁ represents a divergence angle at which a ratio of a laser intensity to a peak intensity is 45%.

(7)

The illumination device according to Item (5) or (6),

in which the lens driving section controls the position of the projection lens such that the movement amount from the first lens position for spot irradiation to the second lens position for area irradiation takes a value equal to or smaller than a predetermined upper limit value depending on the predetermined inter-light source distance.

(8)

The illumination device according to Item (7),

in which the following expression is satisfied:

$$\begin{matrix}[ Math \text{.11} ] & \\ {y}_{max} = EFL - \frac{EFL + sin ( {θ}_{h 2} / 2 )}{sin \{ \frac{A p / 2}{EFL} - \frac{A s / 2}{EFL} + {θ}_{h 2} \}} & \end{matrix}$$

where yₘₐₓ represents the predetermined upper limit value, EFL represents an effective focal length of the projection lens, Ap represents the predetermined inter-light source distance, As represents the predetermined opening size, and θₕ₂ represents a divergence angle at which a ratio of a laser intensity to a peak intensity is 70%.

(9)

The illumination device according to any one of Items (4) to (8), further including:

a diffractive optical element configured to duplicate, in a direction vertical to an optical axis direction, a light emission pattern that is emitted from the light source array and has a predetermined region, to thereby expand an irradiation area.

(10)

The illumination device according to any one of Items (1) to (9),

in which a current that flows through the lens driving section is reduced to zero in a case of area irradiation, and takes a positive value in a case of spot irradiation.

(11)

The illumination device according to any one of Items (3) to (10),

in which the lens driving section includes a voice coil motor or a piezoelectric element.

(12)

The illumination device according to Item (1),

in which the switching section includes a light source driving section configured to control a position of the light emitting section, and

the light source driving section changes the position of the light emitting section,

thereby switching spot irradiation and area irradiation.

(13)

The illumination device according to Item (12),

in which the light emitting section includes a light source array in which a plurality of light sources each configured to emit light with a predetermined opening size are arrayed with a predetermined inter-light source distance, and

the light source driving section controls the position of the light emitting section such that a movement amount from a first light source position for spot irradiation to a second light source position for area irradiation takes a value equal to or larger than a predetermined lower limit value depending on the predetermined inter-light source distance.

(14)

The illumination device according to Item (13),

in which the light source driving section controls the position of the light emitting section such that the movement amount from the first light source position for spot irradiation to the second light source position for area irradiation takes a value equal to or smaller than a predetermined upper limit value depending on the predetermined inter-light source distance.

(15)

The illumination device according to Item (14),

in which the following expressions are satisfied:

$$\begin{matrix}[ Math \text{.12} ] & \\ {y}_{min} = EFL - \frac{EFL + sin ( {θ}_{h 1} / 2 )}{sin \{ \frac{A p / 2}{EFL} - \frac{A s / 2}{EFL} + {θ}_{h 1} \}} & \end{matrix}$$

$${y}_{max} = EFL - \frac{EFL + sin ( {θ}_{h 2} / 2 )}{sin \{ \frac{A p / 2}{EFL} - \frac{A s / 2}{EFL} + {θ}_{h 2} \}}$$

where yₘᵢₙ represents the predetermined lower limit value, yₘₐₓ represents the predetermined upper limit value, EFL represents an effective focal length of the projection lens, Ap represents the predetermined inter-light source distance, As represents the predetermined opening size, θₕ₁ represents a divergence angle at which a ratio of a laser intensity to a peak intensity is 45%, and θₕ₂ represents a divergence angle at which the ratio of the laser intensity to the peak intensity is 70%.

(16)

The illumination device according to Item (1),

in which the switching section includes a variable focus lens, and

the variable focus lens changes a refractive power of the lens, thereby switching spot irradiation and area irradiation.

(17)

The illumination device according to Item (16),

in which the light emitting section includes a light source array in which a plurality of light sources each configured to emit light with a predetermined opening size are arrayed with a predetermined inter-light source distance, and

the variable focus lens changes a shape or refractive index of the lens such that the refractive power of the lens takes a value equal to or larger than a predetermined lower limit value depending on the predetermined inter-light source distance in area irradiation.

(18)

The illumination device according to Item (17),

in which the variable focus lens changes the shape or refractive index of the lens such that the refractive power of the lens takes a value equal to or smaller than a predetermined upper limit value depending on the predetermined inter-light source distance in area irradiation.

(19)

The illumination device according to Item (18),

in which the following expressions are satisfied:

$$\begin{matrix}[ Math \text{.13} ] & \\ {Y}_{p min} = \{ \frac{EFL + sin ( {θ}_{h = 45 \%} / 2 )}{EFL - sin ( \frac{A p / 2}{EFL} - \frac{A s / 2}{EFL} + {θ}_{h} )} \} \times \frac{A}{{EFL}^{2}} & \end{matrix}$$

$${Y}_{p {max}^{=}} \{ \frac{EFL + sin ( {θ}_{h = 70 \%} / 2 )}{EFL - sin ( \frac{A p / 2}{EFL} - \frac{A s / 2}{EFL} + {θ}_{h} )} \} \times \frac{A}{{EFL}^{2}}$$

where Yₚₘᵢₙ represents the predetermined lower limit value, Yₚₘₐₓ represents the predetermined upper limit value, EFL represents an effective focal length of the projection lens, Ap represents the predetermined inter-light source distance, As represents the predetermined opening size, θₕ₁ represents a divergence angle at which a ratio of a laser intensity to a peak intensity is 45%, θₕ₂ represents a divergence angle at which the ratio of the laser intensity to the peak intensity is 70%, and A represents a predetermined constant.

(20)

A ranging module, including:

an illumination device; and

a light receiving section configured to receive reflected light that is light emitted from the illumination device to be reflected by an object,

the illumination device including

a light emitting section,

a projection lens configured to project light that is emitted from the light emitting section, and

a switching section configured to change a focal length to switch spot irradiation and area irradiation.

(21)

A system comprising:

a light emitting section;

a projection lens configured to project light emitted from the light emitting section; and

a switch configured to switch the projected light between a first configuration for area irradiation and a second configuration for spot irradiation.

(22)

The system of Item (21), wherein the switch changes a focal length of the projection lens by moving the projection lens between at least a first position and a second position.

(23) The system of Item (22), wherein in the first position the projection lens performs area irradiation.

(24) The system of Item (22), wherein in the second position the projection lens performs spot irradiation.

(25) The system of Item (21), wherein the light emitting section includes a light source array in which a plurality of light sources configured to emit light with a predetermined opening size are arrayed with a predetermined inter-light source distance.

(26)

The system of Item (25), wherein a light source driving section controls a position of the light emitting section from a first light source position for spot irradiation to a second light source position for area irradiation.

(27)

The system of Item (21), wherein the projection lens is a variable focus lens.

(28)

The system of Item (27), wherein the switch is configured to switch between the first configuration and the second configuration by changing a refractive power of the projection lens.

(29)

A method of driving a system, the method comprising:

projecting light in an area irradiation configuration from a light emitting section of the system through a projection lens of the system;

switching, with a switch of the system, the projected light from the area irradiation configuration to a spot irradiation configuration; and

projecting light in the spot irradiation configuration from the light emitting section through the projection lens.

(30)

The method of Item (29), wherein the switch changes a focal length of the projection lens by moving the projection lens between at least a first position and a second position.

(31)

The method of Item (30), wherein in the first position the projection lens performs area irradiation.

(32)

The method of Item (30), wherein in the second position the projection lens performs spot irradiation.

(33)

The method of Item (30), wherein the light emitting section includes a light source array in which a plurality of light sources configured to emit light with a predetermined opening size are arrayed with a predetermined inter-light source distance.

(34)

The method of Item (30), wherein a light source driving section controls a position of the light emitting section from a first light source position for spot irradiation to a second light source position for area irradiation.

(35)

The method of Item (29), wherein the projection lens is a variable focus lens.

(36)

The method of Item (35), wherein the switch is configured to switch from the area irradiation configuration to the spot irradiation configuration by changing a refractive power of the projection lens.

(37)

A system comprising:

a light emitting section;

a projection lens configured to project light emitted from the light emitting section;

a switch configured to switch between a first configuration for area irradiation and a second configuration for spot irradiation; and

a light receiving section configured to receive reflected light.

(38)

The system of Item (37), wherein the switch changes a focal length of the projection lens by moving the projection lens between at least a first position and a second position.

(39)

The system of Item (38), wherein in the first position the projection lens performs area irradiation.

(40)

The system of Item (38), wherein in the second position the projection lens performs spot irradiation.

### REFERENCE SIGNS LIST

11 Ranging module
12 Illumination device
13 Light emission control section
14 Ranging sensor
15 Light receiving section
16 Signal processing section
42 Light emitting section
43 Diffractive optical element
44 Projection lens
45A, 45B Lens driving section
72A, 72B Light source driving section
91 Variable focus lens
201 Smartphone
202 Ranging module

What is claimed is:

1. A system comprising:
a light emitting section;
a projection lens configured to project light emitted from the light emitting section; and
a switch configured to switch the projected light between a first configuration for area irradiation and a second configuration for spot irradiation.

2. The system of claim 1, wherein the switch changes a focal length of the projection lens by moving the projection lens between at least a first position and a second position.

3. The system of claim 2, wherein in the first position the projection lens performs area irradiation.

4. The system of claim 2, wherein in the second position the projection lens performs spot irradiation.

5. The system of claim 1, wherein the light emitting section includes a light source array in which a plurality of light sources configured to emit light with a predetermined opening size are arrayed with a predetermined inter-light source distance.

6. The system of claim 5, wherein a light source driving section controls a position of the light emitting section from a first light source position for spot irradiation to a second light source position for area irradiation.

7. The system of claim 1, wherein the projection lens is a variable focus lens.

8. The system of claim 7, wherein the switch is configured to switch between the first configuration and the second configuration by changing a refractive power of the projection lens.

9. A method of driving a system, the method comprising:
projecting light in an area irradiation configuration from a light emitting section of the system through a projection lens of the system;
switching, with a switch of the system, the projected light from the area irradiation configuration to a spot irradiation configuration; and
projecting light in the spot irradiation configuration from the light emitting section through the projection lens.

10. The method of claim 9, wherein the switch changes a focal length of the projection lens by moving the projection lens between at least a first position and a second position.

11. The method of claim 10, wherein in the first position the projection lens performs area irradiation.

12. The method of claim 10, wherein in the second position the projection lens performs spot irradiation.

13. The method of claim 9, wherein the light emitting section includes a light source array in which a plurality of light sources configured to emit light with a predetermined opening size are arrayed with a predetermined inter-light source distance.

14. The method of claim 13, wherein a light source driving section controls a position of the light emitting section from a first light source position for spot irradiation to a second light source position for area irradiation.

15. The method of claim 9, wherein the projection lens is a variable focus lens.

16. The method of claim 15, wherein the switch is configured to switch from the area irradiation configuration to the spot irradiation configuration by changing a refractive power of the projection lens.

17. A system comprising:
a light emitting section;
a projection lens configured to project light emitted from the light emitting section;
a switch configured to switch between a first configuration for area irradiation and a second configuration for spot irradiation; and
a light receiving section configured to receive reflected light.

18. The system of claim 17, wherein the switch changes a focal length of the projection lens by moving the projection lens between at least a first position and a second position.

19. The system of claim 18, wherein in the first position the projection lens performs area irradiation.

20. The system of claim 18, wherein in the second position the projection lens performs spot irradiation.
